(19) United States
(12) Patent Application Publication
(10) Pub. No.: US 2024/0058198 A1
(43) Pub. Date: Feb. 22, 2024

(54) MOTION ASSISTANCE DEVICE COMPRISING BALL MOUNT COUPLING STRUCTURE

(71) Applicant: Samsung Electronics Co., Ltd., Suwon-si (KR)

(72) Inventor: Kuemjong BAE, Suwon-si (KR)

(21) Appl. No.: 18/499,635

(22) Filed: Nov. 1, 2023

Related U.S. Application Data
(63) Continuation of application No. PCT/KR2022/007725, filed on May 31, 2022.

(30) Foreign Application Priority Data
Jun. 2, 2021 (KR) 10-2021-0071624
May 17, 2022 (KR) 10-2022-0060188

(51) Int. Cl. A61H 3/00; B25J 9/00

(52) U.S. Cl. CPC A61H 3/00; B25J 9/0006; A61H 1/0244

(57) ABSTRACT

A wearable motion assistance device may include a proximal support part for supporting the proximal portion of a user, a distal support part for supporting the distal portion of the user, and actuator, which is connected to the proximal support part and generates power, a driving frame, which is connected to the actuator and may include a front frame covering the front surface of the distal portion and having a main groove, a slider housing, which is connected to the distal support part and faces the front frame, a slider provided to be slidable in the slider housing, and a knob, which is connected to the slider, can be inserted into the main groove in a state in which the knob is provided to be parallel with the main groove, and is maintained, by at least a pair of ribs, in a state in which the knob is accommodated in the main groove if the knob rotates while inserted into the main groove.

### CROSS-REFERENCE TO RELATED APPLICATIONS

This application is a continuation application of International Application No. PCT/KR2022/007725 designating the United States, filed on May 31, 2022, in the Korean Intellectual Property Receiving Office and claiming priority to Korean Patent Application No. 10-2021-0071624, filed on Jun. 2, 2021, and to Korean Patent Application No. 10-2022-0060188, filed on May 17, 2022, in the Korean Intellectual Property Office, the disclosures of which are all hereby incorporated by reference herein in their entireties.

### BACKGROUND

### Technical Field

Certain example embodiments relate to a motion assistance device including a ball mount coupling structure.

### Description of Related Art

In a rapidly aging society, a growing number of people are complaining of joint-related inconvenience and pain. Accordingly, there is a heightened interest in an assistance device for assisting the elderly or other patients having joint problems or who desire exercise.

A wearable motion assistance device may include a proximal support configured to support a proximal part of a user, a distal support configured to support a distal part of the user, an actuator connected, directly or indirectly, to the proximal support and configured to generate power, and a drive frame configured to transmit the power to the distal support.

However, an instantaneous external force may be applied to the drive frame or the distal support when a user wearing the motion assistance device falls, suddenly changes direction, or walks on a steep slope. When the distal support is directly connected to the drive frame, an external force may be transmitted to the actuator and cause damage. The distal part of the user is bound to the drive frame and at risk of injury. In order to prevent or reduce this, a new design of a structure connecting the drive frame to the distal support may be provided.

### SUMMARY

A motion assistance device according to an example embodiment may include a proximal support configured to support a proximal part of a user, a distal support configured to support a distal part of the user, an actuator connected, directly or indirectly, to the proximal support and configured to generate power, a drive frame including a side frame connected, directly or indirectly, to the actuator and covering a side surface of the distal part, a connecting frame extending from the side frame and having a shape of covering at least a portion of the distal part, a front frame extending from the connecting frame, covering a front surface of the distal part, and including a main groove, and a pair of ribs protruding from the front frame and covering at least part of the main groove, a slider housing connected, directly or indirectly, to the distal support and facing the front frame, a slider provided to be slidable inside the slider housing, and a knob connected, directly or indirectly, to the slider to be inserted into the main groove in a state in which the knob is provided parallel to the main groove, a state in which the knob is accommodated in the main groove being maintained by the pair of ribs when rotated in a state in which the knob is inserted into the main groove.

The knob may have a first width of a first length in a first direction and a second width of a second length in a second direction that intersects with the first direction. The first length may be less than the second length.

The first length may be less than a distance between the pair of ribs and the second length may be greater than the distance between the pair of ribs.

The knob may include a middle knob having the first width and the second width, and a top knob formed to extend from the middle knob, having a partial spherical shape, and maintained in a state of having surface contact with the front frame.

The middle knob may have a rectangular cross section obtained by cutting in the first direction or the second direction.

When the knob is accommodated in the main groove, the top knob may have surface contact with the main groove and may guide a rotational motion of the knob.

The front frame may include a main frame including the main groove, and a cover frame detachably connected, directly or indirectly, to the main frame and configured to support the pair of ribs.

The cover frame and the pair of ribs may be formed of a more flexible material than the main frame.

When a force equal to or greater than a predetermined intensity is applied to the knob in a direction away from the front frame in a state in which the knob is accommodated in the main groove, the pair of ribs may be deformed and the knob may be separated from the main groove.

The pair of ribs may be formed of a more flexible material than the front frame.

At least a portion of the main groove may have a spherical shape, and at least a portion of the knob may have a same curvature as a curvature of the spherical shape.

The pair of ribs may have an inner surface having the same curvature as the curvature of the spherical shape and configured to guide a motion of the knob.

The motion assistance device may further include a knob base formed in a direction from the slider toward the knob and configured to support the knob.

The pair of ribs may be provided on opposite sides of the knob base.

The distal support may include a strap wrapping around the distal part of the user, and a pair of holders connected, directly or indirectly, to the slider housing and supporting the strap.

A motion assistance device according to an example embodiment may include a proximal support configured to support a proximal part of a user, a distal support configured to support a distal part of the user, an actuator connected, directly or indirectly, to the proximal support and configured to generate power, a drive frame connected, directly or indirectly, to the actuator, configured to transmit power to the distal support, and including a main groove and a pair of ribs covering at least a portion of the main groove, a slider housing connected, directly or indirectly, to the distal support and facing the drive frame, a slider provided to be slidable inside the slider housing, and a knob connected, directly or indirectly, to the slider to be inserted into the main groove in a state in which the knob is provided parallel to the main groove, a state in which the knob is accommodated in the drive frame being maintained when rotated in a state in which the knob is inserted into the main groove.

The knob may have a first width of a first length in a first direction and a second width of a second length in a second direction that intersects with the first direction, the first length may be less than the second length and less than a distance between the pair of ribs, and the second length may be greater than the distance between the pair of ribs.

The knob may include a middle knob having the first width and the second width, and a top knob formed to extend from the middle knob, having a partial spherical shape, and maintained in a state of having surface contact with the drive frame.

The drive frame may include a main frame including the main groove, and a cover frame detachably connected, directly or indirectly, to the main groove and configured to support the pair of ribs.

The cover frame and the pair of ribs may be formed of a more flexible material than the main frame.

### BRIEF DESCRIPTION OF DRAWINGS

FIG. 1 is a diagram illustrating a user wearing a motion assistance device according to an example embodiment.

FIG. 2 is a diagram illustrating a state in which a knob is coupled to a drive frame, according to an example embodiment.

FIG. 3 is a diagram illustrating a state in which a knob is separated from a drive frame, according to an example embodiment.

FIG. 4 is a cross-sectional view of the drive frame taken along a line IV-IV of FIG. 3.

FIG. 5 is a bottom view of a drive frame according to an example embodiment.

FIG. 6 is a plan view illustrating a state in which a knob is inserted into a main groove, according to an example embodiment.

FIG. 7 is a plan view illustrating a state in which a knob is accommodated in a main groove when the knob is rotated, according to an example embodiment.

FIG. 8 is a diagram illustrating a cross section of a knob part taken along a line VIII-VIII of FIG. 7.

FIG. 9 is a diagram illustrating a cross section of a knob part taken along a line IX-IX of FIG. 7.

FIG. 10 is a diagram schematically illustrating a motion assistance device worn on an upper arm of a user, according to an example embodiment.

### DETAILED DESCRIPTION

Hereinafter, embodiments are described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It should be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical or scientific terms used herein have the same meaning as those commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto is omitted. In the description of embodiments, detailed description of well-known related structures or functions is omitted when it is deemed that such description may cause ambiguous interpretation of the embodiments.

In addition, in the description of the components of the embodiments, terms such as first, second, A, B, (a), (b), and the like may be used. These terms are used only for the purpose of discriminating one component from another component, and the nature, the sequences, the orders, or the like of the components are not limited by the terms. It is to be understood that if a component is described as being “connected,” “coupled,” or “joined” to another component, the former may be directly “connected,” “coupled,” or “joined” to the latter or “connected,” “coupled,” or “joined” to the latter at least another component.

The same name may be used to describe components having a common function in different embodiments. Unless otherwise mentioned, the description of one embodiment may be applicable to another embodiment. Thus, duplicated description is omitted for conciseness.

It will be noted that in this specification, a +x direction is referred to as the first direction and a +y direction is referred to as the second direction.

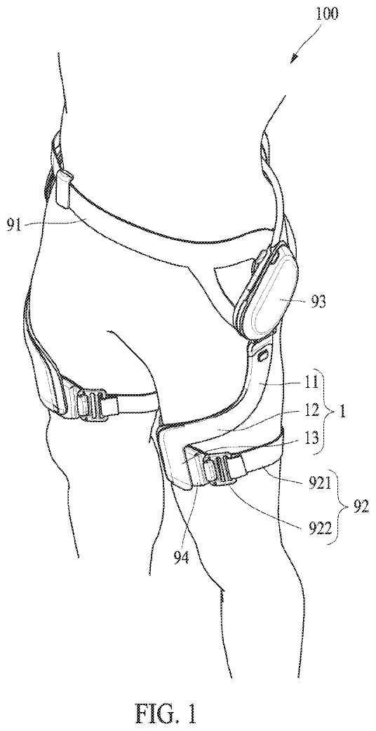

FIG. 1 is a diagram illustrating a user wearing a motion assistance device according to an embodiment.

Referring to FIG. 1, a motion assistance device 100 may be worn by a user to assist a motion of the user. The user may be a human, an animal, a robot, or the like but is not limited thereto. Hereinafter, the motion assistance device 100 is described based on an apparatus assisting walking of a user. Specifically, the motion assistance device 100 may assist walking by assisting a motion of a hip joint of the user. The motion assistance device 100 may include a proximal support 91, a distal support 92, an actuator 93, and a drive frame 1.

In an embodiment, the proximal support 91 and the distal support 92 may be disposed opposite to each other based on one body part of the user and may respectively support a proximal part and a distal part of the user. For example, the proximal support 91 may support a waist and/or pelvis and the like of the user and the distal support 92 may support a thigh, knee, calf, and/or foot, and the like of the user. For example, the proximal support 91 may include a detachable belt for supporting the waist of the user all around. The distal support 92 may include a detachable belt for supporting the thigh of the user all around.

In another example, the proximal support 91 and the distal support 92 may be disposed opposite to each other based on an upper arm of the user. The proximal support 91 may support, for example, a shoulder and/or back and the like and the distal support 92 may support, for example, a forearm and the like. For example, the proximal support 91 may include a detachable belt for supporting the shoulder of the user all around and the distal support 92 may include a detachable belt for supporting the forearm of the user all around or a structure wrapping around the forearm of the user all around.

In an embodiment, the distal support 92 may include a strap 921 and a pair of holders 922.

In an embodiment, the strap 921 may be a detachable belt wrapping around the distal part of the user. The material of the strap 921 may be rubber, leather, cotton, or polyester. However, the material of the strap 921 is not necessarily limited thereto.

In an embodiment, the pair of holders 922 may be connected, directly or indirectly, to a slider housing 94 to be described below and may support the strap 921. The strap 921 may be supported by the holder 922 to stably wrap around the distal part of the user. When the strap 921 is damaged or worn, it may be possible to separate the strap 921 from the holder 922 and replace only the strap 921.

In an embodiment, the proximal support 91 and the distal support 92 may rotate relative to a frontal plane.

In an embodiment, the actuator 93 may be connected, directly or indirectly, to the proximal support 91 and may generate power. The actuator 93 may include, for example, a motor and a speed reducer. The motor may include at least one of a brush motor, a brushless motor, or a stepping motor. The motor may include at least one of an induction motor or a synchronous motor. The speed reducer may include, for example, a gear train.

In an embodiment, the drive frame 1 may transmit power generated by the actuator 93 to the distal support 92. For example, the drive frame 1 may assist a movement of the hip joint of the user. When an output terminal of the actuator 93 rotates in one direction, the drive frame 1 may receive power from the actuator 93 and assist a flexion motion of the hip joint of the user. When the output terminal of the actuator 93 rotates in an opposite direction to the one direction, the drive frame 1 may receive power from the actuator 93 and assist an extension motion of the hip joint of the user. It should be noted that, although the drive frame 1 is described as assisting the motion of the hip joint of the user, a function of the drive frame 1 is not limited thereto. For example, when the motion assistance device 100 is used to assist the motion of joints of the upper body of the user, the drive frame 1 may assist a shoulder or elbow joint of the user. The driving frame 1 may include a side frame 11, a connecting frame 12, a front frame 13, and a pair of ribs.

In an embodiment, the side frame 11 may be connected, directly or indirectly, to the actuator 93 and may cover a side surface of the distal part of the user.

In an embodiment, the connecting frame 12 may extend from the side frame 11 and have a shape of covering at least part of the distal part of the user. The front frame 13 may extend from the connecting frame 12 and cover a front surface of the distal part of the user.

In an embodiment, the front frame 13 may be provided with a main groove. At least part of the main groove may have a spherical shape. The pair of ribs may protrude from the front frame 13 and cover at least part of the main groove.

Due to the shape of the drive frame 1 as described above, force transmission from the drive frame 1 to the distal part of the user may be effectively implemented.

In an embodiment, the motion assistance device 100 may further include a slider housing 94, a slider, and a knob.

In an embodiment, the slider housing 94 may be connected, directly or indirectly, to the distal support 92 and may face the front frame 13. For example, the slider housing 94 may have a shape covering the distal part of the user. The slider housing 94 may be provided with a sliding space in which the slider may move. For example, the sliding space may be formed in an x-axis direction or a y-axis direction.

In an embodiment, the slider may be provided to be slidable inside the slider housing 94. The slider may move along the sliding space. The distal support 92 may move with respect to the drive frame 1.

In an embodiment, the knob may be connected, directly or indirectly, to the slider and accommodated in the main groove. The slider housing 94 may be connected, directly or indirectly, to the front frame 13 through a knob. The distal support 92 may be connected, directly or indirectly, to the drive frame 1. The knob is described in detail below.

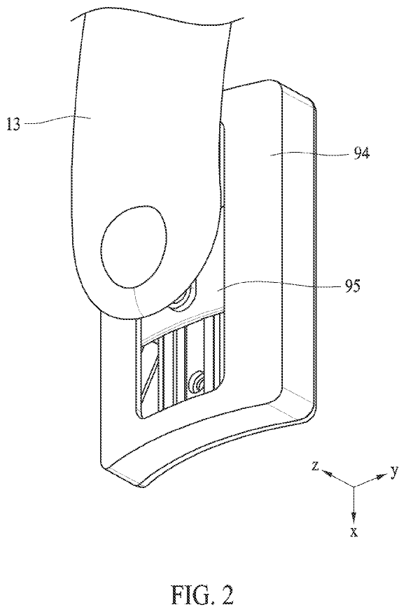

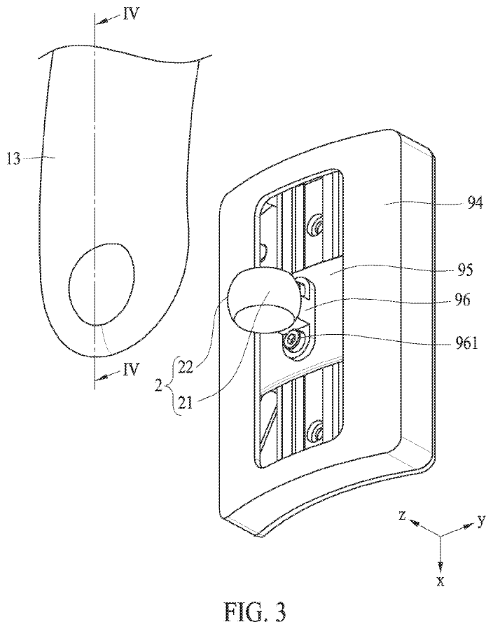

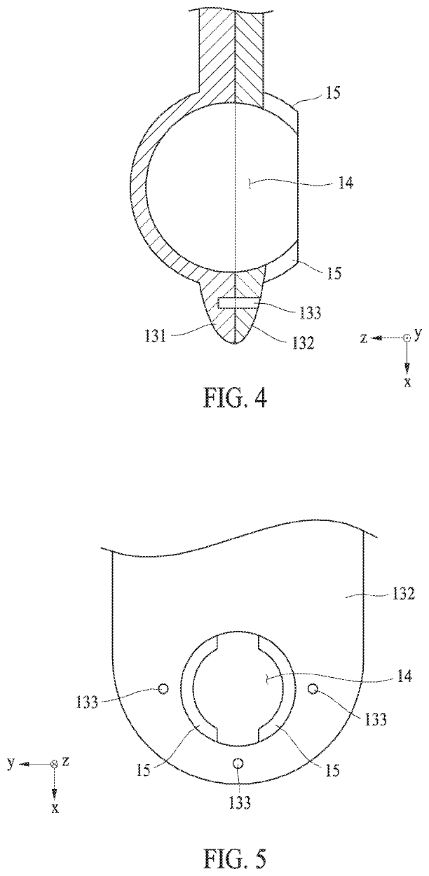

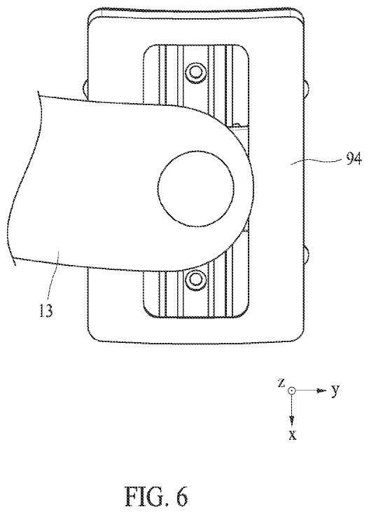

FIG. 2 is a diagram illustrating a state in which a knob is coupled to a drive frame, according to an embodiment. FIG. 3 is a diagram illustrating a state in which a knob is separated from a drive frame, according to an embodiment. FIG. 4 is a cross-sectional view of the drive frame taken along a line IV-IV of FIG. 3. FIG. 5 is a bottom view of a drive frame according to an embodiment.

Referring to FIGS. 2 to 5, the slider housing 94 may be connected, directly or indirectly, to or separated from the drive frame through a ball mount coupling structure.

In an embodiment, a knob 2 may be inserted into a main groove 14. When the knob 2 is rotated in a state in which the knob 2 is inserted into the main groove 14, a state in which the knob 2 is accommodated in the main groove 14 may be maintained. In this case, the knob 2 may form a ball mount coupling structure. The knob 2 may rotate in the main groove 14 along a spherical shape of the main groove 14. The slider housing 94 and the distal support connected, directly or indirectly, to the slider housing 94 may rotate with respect to the drive frame.

In an embodiment, in a state in which the knob 2 is accommodated in the main groove 14, a force equal to or greater than a predetermined intensity may be applied to the knob 2 in a direction away from the front frame 13. For example, an instantaneous external force may be applied to the knob 2 due to a fall of a user and the like. In this case, the knob 2 may be separated from the main groove 14. The slider housing 94 may be separated from the drive frame. The distal support may not be connected to the drive frame. The distal part of the user may move independently from the drive frame. The distal part of the user may be protected from the instantaneous external force. Damage or failure of a motion assistance device may be reduced. For example, the intensity of the external force transmitted to the actuator through the drive frame may be reduced.

In an embodiment, after the knob 2 is separated from the main groove 14, the knob 2 may be accommodated in the main groove 14 again. For example, a user may manually insert the knob 2 into the main groove 14.

It should be noted that the ball mount coupling structure described in an embodiment herein may be applied to various motion assistance devices as well as a motion assistance device for walking assistance. For example, the ball mount coupling structure may be applied to a motion assistance device for assisting a knee joint or an ankle joint and may also be applied to a motion assistance device for the upper body.

In an embodiment, the knob 2 may have a first width of a first length in a first direction. The knob 2 may have a second width of a second length in a second direction that intersects with the first direction. The first length may be less than the second length. The knob 2 may include a middle knob 21 and a top knob 22.

In an embodiment, the middle knob 21 may support the top knob 22. The middle knob 21 may have the first width and the second width. The middle knob 21 may have a rectangular cross section obtained by cutting in the first direction or the second direction. As shown in the drawings of this specification, a cross section of the knob 2 obtained by cutting in the first direction may be part of a circle, and a cross section of the knob 2 obtained by cutting in the second direction may be a rectangular shape. When a cross section of the knob 2 obtained by cutting in one of the first direction and the second direction is part of a circle, part of the middle knob 21 may have the same curvature as the spherical shape of the main groove 14. Part of the middle knob 21 that is of the spherical shape may guide a rotational motion of the knob 2 while in a state of having surface contact with the main groove 14.

In an embodiment, the top knob 22 may be formed extending from the middle knob 21 and may have a partial spherical shape. The top knob 22 may have the same curvature as the spherical shape of the main groove 14. The top knob 22 may have surface contact with the main groove 14 when the knob 2 is accommodated in the main groove 14. The top knob 22 may be maintained in a state of having surface contact with the front frame 13. The top knob 22 may guide the rotational motion of the knob 2. The knob 2 and the slider housing 94 connected to the knob 2 may rotate with respect to the front frame 13. The front frame 13 may include a main frame 131 and a cover frame 132.

In an embodiment, the main frame 131 may be provided with the main groove 14. The cover frame 132 may be detachably connected to the main frame 131. For example, the cover frame 132 may be connected, directly or indirectly, to the main frame 131 by a first fastening element 133. The cover frame 132 may support a pair of ribs 15. The pair of ribs 15 may have an inner surface having the same curvature as the spherical shape that is part of the main groove 14. The pair of ribs 15 may have an inner side surface having the same curvature as at least some part of the knob 2. The knob 2 may be maintained in a state of being accommodated in the main groove 14 by being supported by the rib 15. The rib 15 may guide the rotational motion of the knob 2.

In an embodiment, the pair of ribs 15 may be deformed so that the knob 2 may be separated from the main groove 14. The maximum intensity of force that the rib 15 may accommodate the knob 2 may be set in advance by adjusting factors such as material, thickness, length, and the like of the rib 15. The cover frame 132 and the pair of ribs 15 may be formed of a more flexible material than the main frame 131. The pair of ribs 15 may be formed of a more flexible material than the front frame 13. For example, the pair of ribs 15 may be of a plastic or rubber material. However, it should be noted that the material of the rib 15 is not necessarily limited thereto.

In an embodiment, when the rib 15 is damaged or worn, it may be possible to release the first fastening element 133 and replace only the cover frame 132. The maintenance cost of the motion assistance device may decrease.

In an embodiment, the motion assistance device may further include a knob base 96. The knob base 96 may be formed in a direction from the slider 95 toward the knob 2 and may support the knob 2. For example, the knob base 96 may be connected, directly or indirectly, to the slider 95 by a second fastening element 961. The length measured in the first direction of the knob base 96 may be less than the first length. The length measured in the second direction of the knob base 96 may be less than the second length.

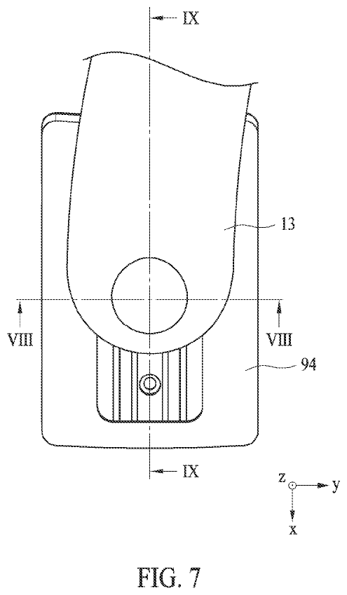

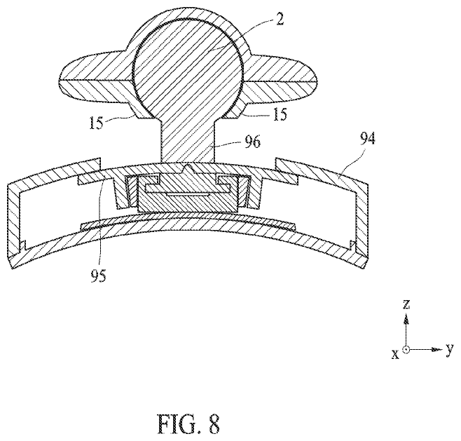

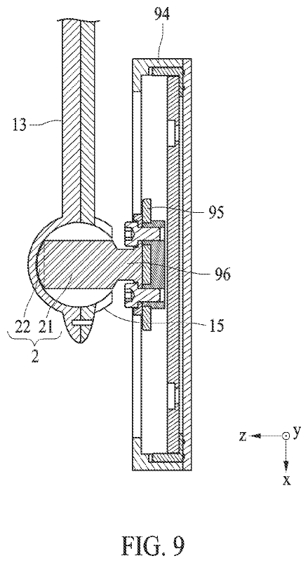

FIG. 6 is a plan view illustrating a state in which a knob is inserted into a main groove, according to an embodiment. FIG. 7 is a plan view illustrating a state in which a knob is accommodated in a main groove when the knob is rotated, according to an embodiment. FIG. 8 is a diagram illustrating a cross section of a knob part taken along a line VIII-VIII of FIG. 7. FIG. 9 is a diagram illustrating a cross section of a knob part taken along a line IX-IX of FIG. 7.

It should be noted that a strap and a pair of holders are omitted in FIGS. 6 to 9 for convenience of description. It should be noted that only a front frame portion of a drive frame is illustrated in FIGS. 6 to 9 for convenience of description.

Referring to FIGS. 6 to 9, the knob 2 may be rotated while in a state of being inserted into the main groove and be accommodated in the main groove. The knob 2 may be inserted into the main groove in a state in which the knob 2 is provided parallel to the main groove. The pair of ribs 15 may be provided on opposite sides of the knob base 96. The first length of the knob 2 may be less than a distance between the pair of ribs 15. A first width of the knob 2 may pass through a gap between at least the pair of ribs 15, and the knob 2 may be inserted into the main groove. When the knob 2 is inserted into the main groove, the top knob 22 may be in contact with the main groove.

In an embodiment, the knob 2 may be rotated while in a state of being accommodated in the main groove. For example, the front frame 13 including the main groove may rotate with respect to the knob 2. For example, the rotation angle of the front frame 13 may be “90” degrees. However, it should be noted that the rotation angle of the front frame 13 is not necessarily limited thereto. When the knob 2 is rotated while in the state of being inserted into the main groove, part of the middle knob 21 that is of the spherical shape may have surface contact with the main groove. The knob 2 may be supported by the pair of ribs 15. A second length of the knob 2 may be greater than a distance between the pair of ribs 15. The knob 2 may have surface contact with the main groove and the pair of ribs 15.

The main groove and the pair of ribs 15 may guide a rotational motion of the knob 2. The knob 2 and the slider 95 connected, directly or indirectly, to the knob 2 may rotate with respect to the drive frame. The slider 95 may move in an x-axis direction or a y-axis direction within a sliding space provided in the slider housing 94. The distal support may be able to move relative to the drive frame and the wearing comfort of a user may be improved. For example, when the user walks, a walking speed, walking direction, or shape of the distal part of the user may change. Even in this case, the position of the slider housing 94 may be fixed relative to the distal part of the user.

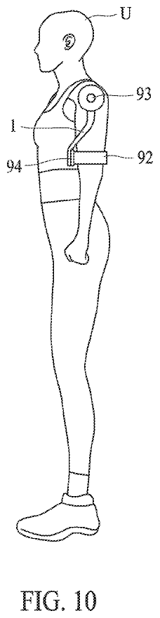

FIG. 10 is a diagram schematically illustrating a motion assistance device worn on an upper arm of a user, according to an embodiment.

Referring to FIG. 10, a motion assistance device may be mounted on the upper arm of a user U. For example, the actuator 93 of the motion assistance device may be provided near a shoulder of the user U and the drive frame 1 may be connected, directly or indirectly, to the actuator 93 and disposed along the upper arm of the user U. The slider housing 94 may be provided on a forearm of the user U. The distal support 92 may wrap around and support the forearm of the user U all around.

While the embodiments are described with reference to a limited number of drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and equivalents to the claims are also within the scope of the following claims.

1. A wearable motion assistance device comprising:
a proximal support configured to support a proximal part of a user;
a distal support configured to support a distal part of the user;
an actuator, comprising a motor, connected to the proximal support and configured to generate power;
a drive frame comprising a side frame connected to the actuator and configured for covering a side surface of the distal part, a connecting frame extending from the side frame and comprising a shape of configured for covering at least a portion of the distal part, a front frame extending from the connecting frame, configured for covering a front surface of the distal part, and comprising a main groove, and a pair of ribs protruding from the front frame and covering at least a portion of the main groove;
a slider housing connected to the distal support and facing the front frame;
a slider provided to be slidable inside the slider housing; and
a knob connected to the slider and configured to be inserted into the main groove in a state in which the knob is provided parallel to the main groove, a state in which the knob is accommodated in the main groove to be maintained by the pair of ribs when rotated in a state in which the knob is inserted into the main groove.

2. The motion assistance device of claim 1, wherein
the knob has a first width of a first length in a first direction and a second width of a second length in a second direction that intersects with the first direction, and
the first length is less than the second length.

3. The motion assistance device of claim 2, wherein the first length is less than a distance between the pair of ribs and the second length is greater than the distance between the pair of ribs.

4. The motion assistance device of claim 2, wherein the knob comprises:
a middle knob having the first width and the second width; and
a top knob formed to extend from the middle knob, having a partial spherical shape, and configured to be maintained in a state of having surface contact with the front frame.

5. The motion assistance device of claim 4, wherein the middle knob has a rectangular cross section obtained by cutting in the first direction or the second direction.

6. The motion assistance device of claim 4, wherein, when the knob is accommodated in the main groove, the top knob has surface contact with the main groove and guides a rotational motion of the knob.

7. The motion assistance device of claim 1, wherein the front frame comprises:
a main frame comprising the main groove; and
a cover frame detachably connected to the main frame and configured to support the pair of ribs.

8. The motion assistance device of claim 7, wherein the cover frame and the pair of ribs are formed of a more flexible material than the main frame.

9. The motion assistance device of claim 7, wherein, the knob and ribs are configured so that when a force equal to or greater than a predetermined intensity is applied to the knob in a direction away from the front frame in a state in which the knob is accommodated in the main groove, the pair of ribs are deformed and the knob is separated from the main groove.

10. The motion assistance device of claim 1, wherein the pair of ribs are formed of a more flexible material than the front frame.

11. The motion assistance device of claim 1, wherein
at least a portion of the main groove has a spherical shape, and
at least a portion of the knob has a same curvature as a curvature of the spherical shape.

12. The motion assistance device of claim 11, wherein the pair of ribs have an inner surface having the same curvature as the curvature of the spherical shape and configured to guide a motion of the knob.

13. The motion assistance device of claim 12, further comprising a knob base formed in a direction from the slider toward the knob and configured to support the knob.

14. The motion assistance device of claim 13, wherein the pair of ribs are provided on opposite sides of the knob base.

15. The motion assistance device of claim 1, wherein the distal support comprises:
a strap for wrapping around the distal part of the user; and
a pair of holders connected to the slider housing and supporting the strap.

16. A motion assistance device comprising:
a proximal support configured to support a proximal part of a user;
a distal support configured to support a distal part of the user;
an actuator, comprising a motor, connected to the proximal support and configured to generate power;
a drive frame connected to the actuator, configured to transmit power to the distal support, and comprising a main groove and a pair of ribs covering at least a portion of the main groove;
a slider housing connected to the distal support and facing the drive frame;
a slider configured to be slidable inside the slider housing; and
a knob connected to the slider configured to be inserted into the main groove in a state in which the knob is provided parallel to the main groove, a state in which the knob is accommodated in the drive frame to be maintained when rotated in a state in which the knob is inserted into the main groove.

17. The motion assistance device of claim 16, wherein
the knob has a first width of a first length in a first direction and a second width of a second length in a second direction that intersects with the first direction,
the first length is less than the second length and less than a distance between the pair of ribs, and
the second length is greater than the distance between the pair of ribs.

18. The motion assistance device of claim 17, wherein the knob comprises:
a middle knob having the first width and the second width; and
a top knob formed to extend from the middle knob, having a partial spherical shape, and configured to be maintained in a state of having surface contact with the drive frame.

19. The motion assistance device of claim 16, wherein the drive frame comprises:
a main frame comprising the main groove; and
a cover frame detachably connected to the main groove and configured to support the pair of ribs.

20. The motion assistance device of claim 19, wherein the cover frame and the pair of ribs are formed of a more flexible material than the main frame.
